(19) United States
(12) Patent Application Publication
(10) Pub. No.: US 2012/0011536 A1
(43) Pub. Date: Jan. 12, 2012

(54) METHOD AND APPARATUS FOR PROVIDING ACCESS TO A SUBSCRIPTION BROADCAST CHANNEL ON DEMAND VIA A COMMUNICATIONS NETWORK

(75) Inventors: Shengqiang Wang, Cary, NC (US); Ranjan Sharma, New Albany, OH (US); Yigang Cai, Naperville, IL (US)

(73) Assignee: Alcatel-Lucent USA Inc., Murray Hill, NJ (US)

(21) Appl. No.: 12/833,343

(22) Filed: Jul. 9, 2010

(51) Int. Cl. H04N 7/16

(52) U.S. Cl. 725/27

(57) ABSTRACT

A request to provide access to a specified subscription broadcast channel during a specified period is received from a subscriber device. A first instruction to allow the subscriber device to access the specified subscription broadcast channel is transmitted to a second device, prior to the specified period. A second instruction to restrict access by the subscriber device to the specified subscription broadcast channel is transmitted to the second device, substantially at the end of the specified period.

### FIELD OF THE INVENTION

This specification relates to provisioning of multimedia content via a communications network, and more particularly to methods and apparatus for providing access to a subscription broadcast channel on demand for a specified period of time via a communications network.

### BACKGROUND

Use of Internet Protocol television (IPTV) networks to deliver television programs and other multimedia content via communications networks has become common. In many IPTV networks, a service provider offers access to one or more subscription broadcast channels on a subscription basis. The service provider may offer to subscribers one or more service “packages” which allow access to respective sets of subscription broadcast channels. A subscriber who wishes to gain access to additional channels or otherwise change his or her service package typically is required to contact the service provider's customer service department (by telephone, for example) and subscribe to the additional channels.

### SUMMARY OF THE INVENTION

Existing IPTV systems do not provide an opportunity for a subscriber to view particular program content scheduled to be shown on a subscription broadcast channel that is not currently in the subscriber's service package, without altering the service package. Therefore, there exists a need for improved systems and methods for providing access to subscription broadcast channels in IPTV networks.

In accordance with an embodiment of the invention, a method for providing multimedia content to a user of a network is provided. A request to provide access to a specified subscription broadcast channel during a specified period is received from a subscriber device. A first instruction to allow the subscriber device to access the specified subscription broadcast channel is transmitted to a second device, prior to the specified period. A second instruction to restrict access by the subscriber device to the specified subscription broadcast channel is transmitted to the second device, substantially at the end of the specified period.

In one example, the period specified in the request is different from a subscription period (having predetermined start and end times) associated with the specified subscription broadcast channel, which is offered by a service provider to subscribers on a subscription basis. The request may include a request to provide access to the specified subscription broadcast channel during the specified period, on a non-subscription basis. The request may include information relating to an identifier of the subscriber device, an identifier of the specified subscription broadcast channel, a start time of the specified period, and an end time of the specified period.

In accordance with other embodiments of the invention, systems and apparatus for providing multimedia content to a user of a network are provided. In particular, systems and apparatus which may be used to implement the methods described above are provided.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a communication system that may be used to provide multimedia content, in accordance with an embodiment of the invention;

FIG. 2 is an example of a subscriber profile, in accordance with an embodiment of the invention;

FIG. 3 shows components of an access management server, in accordance with an embodiment of the invention;

FIG. 4 is an example of a request message that a subscriber device may transmit, in accordance with an embodiment of the invention;

FIG. 5 is a flowchart depicting a method of providing access to a subscription broadcast channel on demand during a requested period of time, in accordance with an embodiment of the invention;

FIG. 6 shows a service-on-demand request database, in accordance with an embodiment of the invention;

FIG. 7 shows the subscriber profile of FIG. 2 after it has been updated, in accordance with an embodiment of the invention; and

FIG. 8 shows components of a computer, in accordance with an embodiment of the invention.

### DETAILED DESCRIPTION

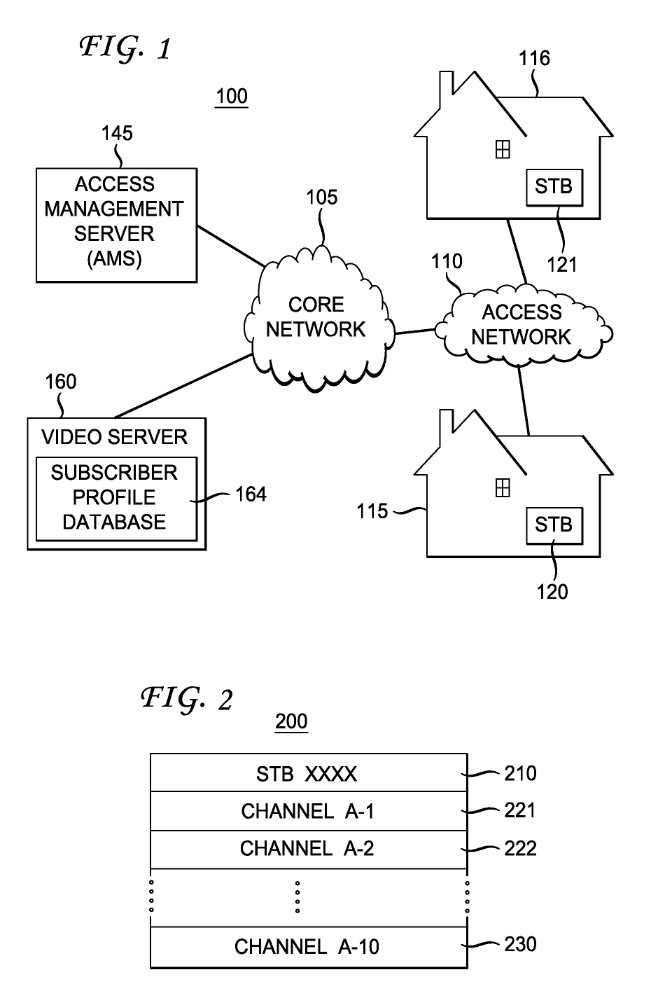

FIG. 1 shows a communication system 100 that may be used to provide multimedia content, in accordance with an embodiment of the invention. Communication system 100 comprises a core network 105, an access management server (“AMS”) 145, and a content delivery device, which in this embodiment comprises a video server 160. Communication system 100 also comprises an access network 110, and a plurality of subscriber devices including, in this example, set-top box (“STB”) 120 and STB 121, located respectively at subscriber premises 115 and 116.

In the exemplary embodiment of FIG. 1, core network 105 comprises an optical network. Use of optical networks is known. In other embodiments, core network 105 may comprise other types of networks.

Access network 110 is linked to core network 105 and to one or more subscriber devices, including STBs 120, 121. Access network 110 may comprise a cable network, a DSL network, a Gigabit-capable passive optical network (“GPON”), and/or other types of networks. While a single access network 110 is shown in the example of FIG. 1, communication network 100 may comprise more than one access network. Similarly, while only two STBs 120, 121, and two subscriber premises 115, 116 are shown in FIG. 1, access network 110 may be connected to any number of subscriber devices located at respective subscriber premises. Subscribers may also use other types of subscriber devices, such as personal computers, to connect to access network 110.

In an embodiment of the invention, data (including multimedia content provided via subscription broadcast channels) is transmitted within communication system 100 in accordance with Internet Protocol (IP) communication standards. In other embodiments other methods and/or protocols may be used to provide subscription broadcast channels to subscribers.

In the exemplary embodiment, a service provider distributes to subscribers multimedia program content, such as television channels, videos, etc., via communication network 100. For convenience, certain aspects of communication system 100 are described below with reference to STB 120 and subscriber residence 115; however, this description is equally applicable to STB 121 and subscriber residence 116, and to any other set-top box (or other subscriber device) and/or subscriber residence that may be associated with communication system 100.

STB 120 is a set-top box connected to a television or other display device. STB 120 is connected to access network 110 and transmits and receives signals relating to multimedia program content, commands, electronic program guides, and other information via access network 110.

A subscriber residing at subscriber premises 115 uses STB 120 to view program content provided by the service provider. In one example, the service provider offers access to one or more subscription broadcast channels on a subscription basis. The service provider may offer service “packages” which allow access to respective sets of subscription broadcast channels. Each subscription broadcast channel is broadcast via communication system 100 simultaneously to multiple subscriber devices, including STB 120 and STB 121.

Each subscription broadcast channel is available to subscribers, on a subscription basis, for one or more predetermined subscription periods, for example, on a monthly basis from the beginning to the end of a month. Accordingly, when a subscriber subscribes to a particular subscription broadcast channel, the subscriber gains access to the subscription broadcast channel for at least one subscription period associated with the channel. Similarly, when a subscriber subscribes to a selected service package, the subscriber gains access to a predetermined set of subscription broadcast channels associated with the service package for at least one subscription period. Typically, a subscriber can access the subscription broadcast channels specified in the subscriber's service package at any time during the respective subscription period. The subscriber is typically charged a predetermined amount for the subscription. Among the subscription broadcast channels available in various service packages, some channels may be designated “regular” subscription broadcast channels while others may be designated “premium” subscription broadcast channels.

A service provider may also distribute multimedia program content to subscribers via one or more subscription multicast channels. Use of subscription multicast channels to deliver multimedia program content is known.

In addition to subscription broadcast channels (and subscription multicast channels) available in service packages, the service provider also may offer selected multimedia programs through a video-on-demand (“VOD”) service. A VOD service provides a selection of multimedia programs to subscribers for viewing at any time, on demand. When a subscriber chooses to use the VOD service to view a program, a designated VOD channel is established for a subscriber device associated with the subscriber and is used to transmit the VOD program uniquely to that device. The VOD channel established in this manner cannot be accessed by other subscriber devices. The service provider may also provide selected programming content via one or more pay-per-view (“PPV”) channels, which subscribers can view selectively. PPV channels are designated channels provided by the service provider with selected PPV programs, which are typically not available via the service provider's subscription broadcast channels. Typically, subscribers may access a PPV channel and view a PPV program, for a charge.

AMS 145 provides provisioning services with respect to multimedia content within communication system 100. For example, AMS 145 may communicate with subscriber devices, including STBs 120 and 121, and cause video server 160 to provide multimedia programs to STBs 120 and 121. AMS 145 may also manage customer accounts to ensure that charges associated with certain services are properly made.

Video server 160 transmits signals associated with respective subscription broadcast channels to subscriber devices within communication system 100 in accordance with the subscribers' service packages and/or the service provider's policies. Video server 160 may also distribute video and other multimedia content (including VOD and PPV channels) to subscribers in accordance with the subscribers' service packages and/or the service provider's policies. Video server 160 may receive signals associated with various subscription broadcast channels from various sources, including one or more content providers, for example, and transmit the signals to subscribers. Video server 160 may also obtain multimedia content, such as video programs, from one or more databases, and distribute the content to subscribers.

In the exemplary embodiment of FIG. 1, video server 160 is implemented using a computer, such as a workstation, mainframe computer, personal computer, etc. Other types of processing devices may be used.

Video server 160 maintains a subscriber profile database 164 that stores profiles associated with respective subscribers and/or subscriber devices. FIG. 2 is an example of a subscriber profile 200 associated with STB 120 that may be stored in subscriber profile database 164, in accordance with an embodiment of the invention. Suppose, in this example, that the subscriber residing in subscriber premises 115 has subscribed to a service package granting access to subscription broadcast channels A-1, A-2, . . . , A-10. Accordingly, subscriber profile 200 stores in record 210 an identifier (“STB XXXX”) associated with STB 120. Records 221-230 store identifiers of the subscription broadcast channels that STB 120 is authorized to access.

In other embodiments, distribution of signals associated with subscriber broadcast channels, maintenance of subscriber profiles and provisioning and distribution of other multimedia content may be performed by other content delivery devices within communications system 100. For example, in an alternative embodiment, maintenance of subscriber profiles and provisioning and distribution of multimedia content is performed by a component of access network 110, such as a digital subscriber line access management access multiplexer (“DSLAM”) system (not shown). In another embodiment, maintenance of subscriber profiles and provisioning and distribution of multimedia content is performed by an optical line terminal (not shown) within system 100.

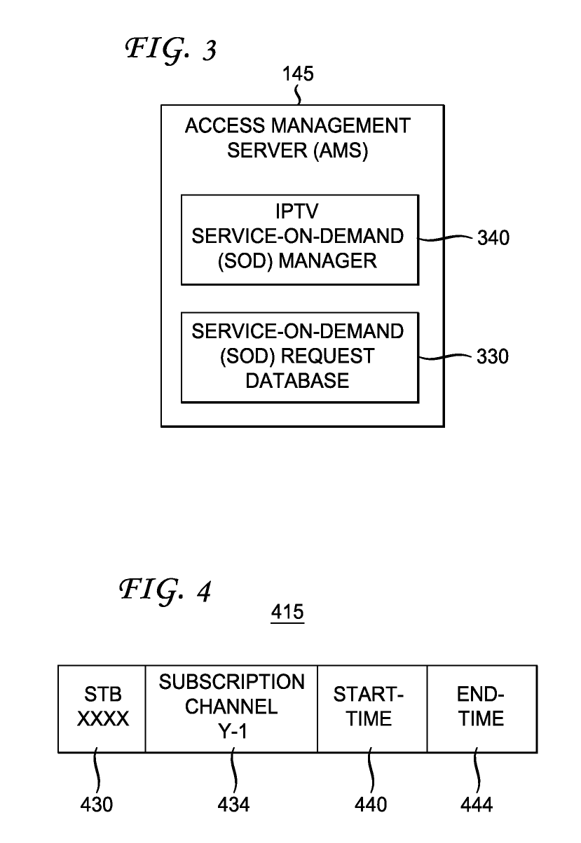

FIG. 3 is a block diagram of functional components of AMS 145, in accordance with an embodiment of the invention. AMS 145 comprises an IPTV Service-on-Demand (SOD) manager 340 and a Service-on-Demand (SOD) request database 330. In other embodiments, AMS 145 may comprise other components. AMS 145 may comprise a computer, such as a workstation, mainframe computer, personal computer, etc.

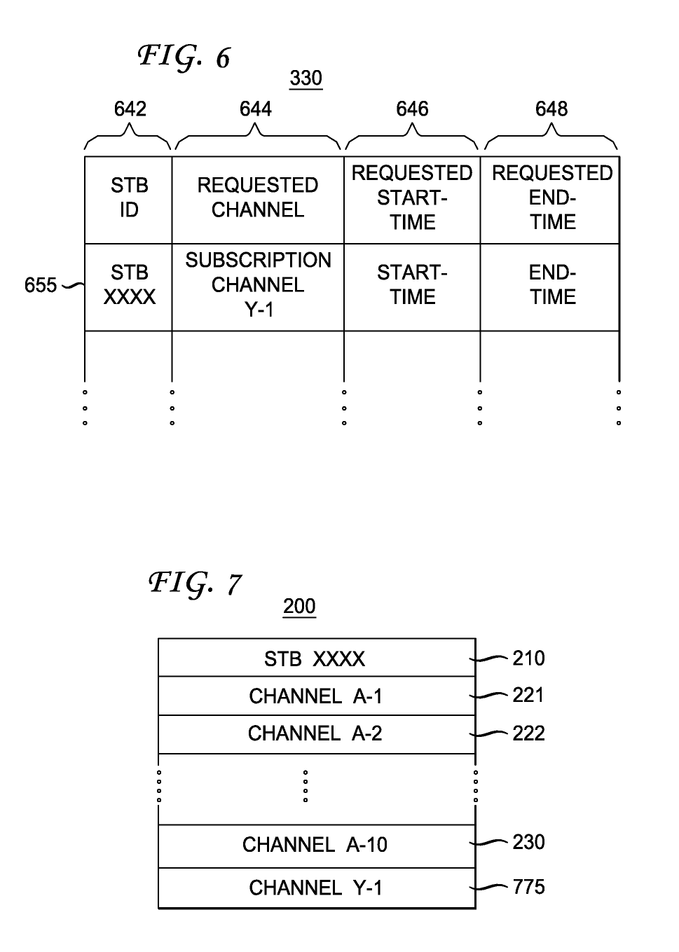

SOD manager 340 provides service-on-demand functionality with respect to subscriber broadcast channels available within communication system 100. SOD manager 340 may from time to time receive from a subscriber device a request to provide access to a subscriber broadcast channel for a specified period of time, and store data pertaining to the request in a service-on-demand (SOD) request database 330. SOD request database 330, which is illustrated in FIG. 6 and discussed further below, may comprise information stored in a memory or storage device, for example.

In accordance with an embodiment of the invention, SOD manager 340 receives from a subscriber device a request to provide access to a specified subscriber broadcast channel for a specified period of time. In response, SOD manager 340 causes video server 160 to allow the requesting subscriber device to access the requested channel during the specified time period.

Suppose, in an exemplary embodiment, that the subscriber residing in subscriber premises 115 wishes to gain access to subscription broadcast channel Y-1 (which is not included in the subscriber's service package) for the time period starting at START TIME and ending at END TIME, on a non-subscription basis. The subscriber uses a remote control device to enter information pertinent to this request via STB 120. STB 120 generates a message based on the information provided by the subscriber, and transmits the request message to SOD manager 340. FIG. 4 is an example of a request message 415 that STB 120 may transmit to SOD manager 340, in accordance with an embodiment of the invention. Request message 415 comprises a field 430 comprising an identifier of STB 120, and a field 434 comprising information specifying the requested subscription channel (Y-1). Request message 415 also comprises fields 440 and 444 storing, respectively, information indicating the requested start time (START TIME) and end time (END TIME). Request message 415 may comprise other information as well, such as header information. In another embodiment, request message 415 may also comprise a further request for additional permissions, for example, a request for authorization to record content on a digital video recorder (“DVR”). Authorization to record content may be granted with a stipulation that the recorded content is viewable only for a predetermined period (for example, twenty-four hours).

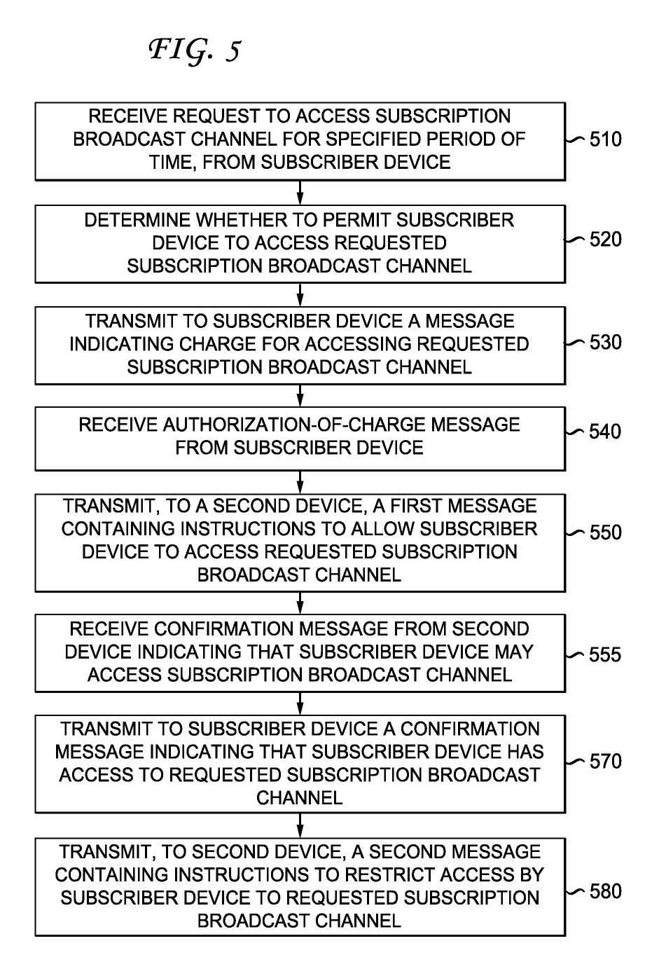

FIG. 5 is a flowchart depicting a method of providing to a subscriber device access to a subscription broadcast channel on demand during a requested period of time, in accordance with an embodiment of the invention. At step 510, a request for access to a subscription broadcast channel for a specified period of time is received from a subscriber device. In this example, SOD manager 340 receives request message 415 from STB 120 containing information relating to the subscriber's request to access subscription channel Y-1 during the time period starting at START TIME and ending at END TIME, on a non-subscription basis.

At step 520, SOD manager 340 examines the request and determines whether or not to permit STB 120 to access the requested subscription channel during the requested time period. The determination may be made based on policies of the service provider. The service provider may prohibit a particular channel from being shown within a defined geographical region, for example. If the request is not permitted, a message is transmitted to the requesting set-top box.

Supposing that SOD manager 340 allows the request, at step 530 SOD manager 340 transmits a response message to STB 120 indicating the charge for accessing the requested subscription broadcast channel for the specified time period. When the subscriber authorizes the charge, by clicking an appropriate button on the subscriber's remote control device, for example, and/or by entering a code, STB 120 transmits an authorization-of-charge message to SOD manager 340. SOD manager 340 receives the authorization-of-charge message at step 540. SOD manager 340 does not proceed further until the authorization-of-charge message is received.

When the authorization-of-charge message is received from STB 120, SOD manager 340 retrieves information from request message 415 and stores the information in SOD request database 330. FIG. 6 shows SOD request database 330, in accordance with an embodiment of the invention. SOD request database 330 comprises four columns 642, 644, 646, and 648, storing, respectively, information indicating a set-top box identifier, a requested subscription broadcast channel, a requested start time, and a requested end time. When SOD manager 340 receives request message 415, SOD manager 340 creates a record 655 in SOD request database 330 indicating that a request has been received to allow STB XXXX to access subscription channel Y-1 between START TIME and END TIME.

SOD manager 340 monitors the current time, and monitors records stored in SOD request database 330, to determine when video server 160 must be instructed to authorize a set-top box to access a requested subscription broadcast channel. Referring again to FIG. 5, at step 550, a first message containing instructions to allow a subscriber device access to a requested subscription broadcast channel is transmitted to a second device, prior to a start time indicated in the associated request. In the exemplary embodiment, SOD manager 340 examines record 655 in SOD request database 330 and, prior to START TIME, transmits a message to video server 160 indicating that STB XXXX is authorized to access subscription channel Y-1.

In response, video server 160 updates subscriber profile 200 in subscriber profile database 164 to indicate that STB XXXX is authorized to access subscription channel Y-1. FIG. 7 shows subscriber profile 200 after it has been updated by video server 160, in accordance with an embodiment of the invention. Record 775 has been added to subscriber profile 200 to indicate that STB 120 now has access to channel Y-1. Video server 160 transmits to SOD manager 340 a confirmation message indicating that STB XXXX has been authorized to access subscription broadcast channel Y-1.

Upon receipt of the confirmation message from video server 160 (at step 555), SOD manager 340 generates a call detail record (“CDR”), which may be stored in memory. The CDR may be used subsequently to ensure that the subscriber is properly charged. The CDR may indicate the STB identifier, the requested channel, the specified start time and end time.

At step 570, SOD manager 340 also transmits a confirmation message to STB 120 indicating that STB 120 now has access to subscription broadcast channel Y-1. Once STB 120 receives the confirmation message, the subscriber may begin viewing channel Y-1.

SOD manager 340 continues to monitor the records stored in SOD request database 330, and the current time, to determine when a message must be transmitted to video server 160 to cause video server 160 to remove access to a requested subscription broadcast channel. When SOD manager 340 determines that the end time associated with a request is imminent or has passed, at step 580, a second message containing instructions to restrict (or remove/discontinue) access by a subscriber device to the requested subscription broadcast channel is transmitted to the second device. Accordingly, at or around END TIME, SOD manager 340 transmits a message to video server 160 indicating that STB XXXX is no longer authorized to access subscription broadcast channel Y-1. SOD manager 340 also generates a CDR indicating that access by STB 120 to channel Y-1 has been terminated.

In response to the message from SOD manager 340, video server 160 removes record 775 (which indicates access to channel Y-1) from subscriber profile 200. Video server 160 transmits a confirmation message to SOD manager 340 indicating that STB 120 no longer has access to subscription broadcast channel Y-1. SOD manager 340, or video server 160, may also transmit a message to STB 120 indicating that access to subscription broadcast channel Y-1 has been discontinued.

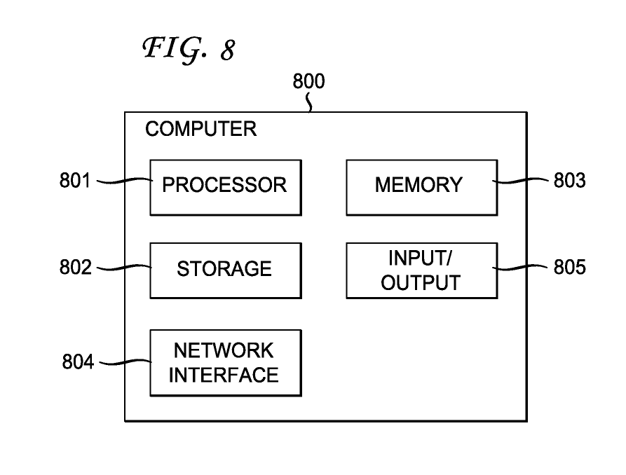

The above-described methods can be implemented on a computer using well-known computer processors, memory units, storage devices, computer software, and other components. A high-level block diagram of such a computer is illustrated in FIG. 8. Computer 800 contains a processor 801, which controls the overall operation of computer 800 by executing computer program instructions that define such operations. The computer program instructions may be stored in a storage device 802, or other computer readable medium (e.g., magnetic disk, CD ROM, etc.), and loaded into memory 803 when execution of the computer program instructions is desired. Thus, the method steps of FIG. 5 can be defined by the computer program instructions stored in the memory 803 and/or storage 802 and controlled by the processor 801 executing the computer program instructions. For example, the computer program instructions can be implemented as computer executable code programmed by one skilled in the art to perform an algorithm defined by the method steps of FIG. 5. Accordingly, by executing the computer program instructions, the processor 801 executes an algorithm defined by the method steps of FIG. 5. The computer 800 also includes one or more network interfaces 804 for communicating with other devices via a network. The computer 800 also includes one or more input/output devices 805 that enable user interaction with the computer 800 (e.g., display, keyboard, mouse, speakers, buttons, etc.). One skilled in the art will recognize that an implementation of an actual computer could contain other components as well, and that FIG. 8 is a high level representation of some of the components of such a computer for illustrative purposes.

The systems and methods that are described herein for providing access to a subscription broadcast channel on demand may also be used to provide access to a subscription multicast channel on demand.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for providing multimedia content to a user of a network, the method comprising:
receiving, from a subscriber device, a request to provide access to a specified subscription broadcast channel during a specified period;
transmitting to a second device, prior to the specified period, a first instruction to allow the subscriber device to access the specified subscription broadcast channel; and
transmitting to the second device a second instruction to restrict access by the subscriber device to the specified subscription broadcast channel, substantially at the end of the specified period.

2. The method of claim 1, wherein:
the specified subscription broadcast channel is offered by a service provider to subscribers, on a subscription basis, for a subscription period having a predetermined start time and a predetermined end time; and
the specified period is different from the subscription period.

3. The method of claim 2, wherein the request comprises a request to provide access to the specified subscription broadcast channel during the specified period, on a non-subscription basis.

4. The method of claim 1, wherein the request comprises information relating to an identifier of the subscriber device, an identifier of the specified subscription broadcast channel, a start time of the specified period, and an end time of the specified period.

5. The method of claim 4, further comprising:
determining, prior to the start time, that the first instruction is to be transmitted to the second device, based at least in part on a current time and on the information relating to the start time.

6. The method of claim 1, wherein the second device comprises at least one of: a video server, a digital subscriber line access management access multiplexer, and an optical line terminal.

7. An apparatus for providing multimedia content to a user of a network, the apparatus comprising:
means for receiving, from a subscriber device, a request to provide access to a specified subscription broadcast channel during a specified period;
means for transmitting to a second device, prior to the specified period, a first instruction to allow the subscriber device to access the specified subscription broadcast channel; and
means for transmitting to the second device a second instruction to restrict access by the subscriber device to the specified subscription broadcast channel, substantially at the end of the specified period.

8. The apparatus of claim 7, wherein:
the specified subscription broadcast channel is offered by a service provider to subscribers, on a subscription basis, for a subscription period having a predetermined start time and a predetermined end time; and
the specified period is different from the subscription period.

9. The apparatus of claim 8, wherein the request comprises a request to provide access to the specified subscription broadcast channel during the specified period, on a non-subscription basis.

10. The apparatus of claim 7, wherein the request comprises information relating to an identifier of the subscriber device, an identifier of the specified subscription broadcast channel, a start time of the specified period, and an end time of the specified period.

11. The apparatus of claim 10, further comprising:
means for determining, prior to the start time, that the first instruction is to be transmitted to the second device, based at least in part on a current time and on the information relating to the start time.

12. The apparatus of claim 7, wherein the second device comprises at least one of: a video server, a digital subscriber line access management access multiplexer, and an optical line terminal.

13. A system for providing multimedia content to a user of a network, the system comprising:
a content delivery device configured to deliver multimedia programs to a plurality of subscriber devices via a network; and
a processor configured to:
receive, from a subscriber device, a request to provide access to a specified subscription broadcast channel during a specified period;
transmit to the content delivery device, prior to the specified period, a first instruction to allow the subscriber device to access the specified subscription broadcast channel; and
transmit to content delivery device a second instruction to restrict access by the subscriber device to the specified subscription broadcast channel, substantially at the end of the specified period.

14. The system of claim 13, wherein:
the specified subscription broadcast channel is offered by a service provider to subscribers, on a subscription basis, for a subscription period having a predetermined start time and a predetermined end time; and
the specified period is different from the subscription period.

15. The system of claim 14, wherein the request comprises a request to provide access to the specified subscription broadcast channel during the specified period, on a non-subscription basis.

16. The system of claim 13, wherein the request comprises information relating to an identifier of the subscriber device, an identifier of the specified subscription broadcast channel, a start time of the specified period, and an end time of the specified period.

17. The system of claim 16, wherein the processor is further configured to:
determine, prior to the start time, that the first instruction is to be transmitted to the content delivery device, based at least in part on a current time and on the information relating to the start time.

18. The system of claim 13, wherein the content delivery device comprises at least one of: a video server, a digital subscriber line access management access multiplexer, and an optical line terminal.
